(19) United States
(12) Patent Application Publication
(10) Pub. No.: US 2005/0084310 A1
(43) Pub. Date: Apr. 21, 2005

(54) Ribbon cassette for thermal transfer printer

(75) Inventors: Hitoshi Funaki, Fukushima-ken (JP); Shigeto Tokuta, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/963,709

(22) Filed: Oct. 13, 2004

(30) Foreign Application Priority Data
Oct. 16, 2003 (JP) 2003-356515
Oct. 16, 2003 (JP) 2003-356516

(51) Int. Cl. B41J 32/00

(52) U.S. Cl. 400/208

(57) ABSTRACT

A ribbon cassette contains an ink ribbon, a supply core and winding core around which ends of the ink ribbon are wound, a cassette case for rotatably supporting the supply rewinding cores, and a ribbon guide part guiding the path of the ink ribbon. The ink ribbon guide part is a meandering preventing portion constructed such that a portion of the ink ribbon guide part to be brought into slidable contact with a widthwise middle portion of the ink ribbon is wider than portions to be brought into slidable contact with widthwise ends of the ink ribbon. Further, by fitting both ends of a guide shaft for guiding the ink ribbon into first and second holes formed in first and second wall portions formed on the cassette case, the guide shaft 8 is rotatably supported in the first and second holes.

### BACKGROUND OF THE INVENTION

1. Field of the Invention

The present invention relates to a ribbon cassette used in a thermal transfer printer, and more particularly, to a ribbon cassette for a thermal transfer printer which has a ribbon guide section capable of guiding the travel of an ink ribbon supplied from a supply core to be wound around a winding core.

2. Description of the Related Art

A conventional ribbon cassette used in a thermal transfer printer such as a photo printer capable of high-precision printing, and the like, has a construction as shown in FIG. 5.

Referring to FIG. 5, a conventional ribbon cassette 21 typically has a cassette case 22 formed of a resinous material, and a wide and lengthened ink ribbon 23 as shown by the two-dot chain lines is laid in the cassette case 22.

The ink ribbon 23 is wound around a supply core 24 and a winding core 25. The supply core 24 and the winding core 25 are received in and rotatably supported by a hollow first core support portion 26 and a hollow second core support portion 27, respectively, which are formed in the cassette case 22.

A ribbon supply part 26a is formed in the first core support portion 26 to pay off the ink ribbon 23 wound around the supply core 24. The ribbon supply part 26a is composed of a first wall 26b and a second wall 26c which are opposed to each other and is formed in the shape of a slit with a predetermined gap between them. An opening 22a is formed between the first core support portion 26 and the second core support portion 27. A thermal head (not shown) of the thermal transfer printer is located in the opening 22a to press the ink ribbon 23 against a recording paper which is positioned on a platen roller (not shown).

A guide shaft 28 is rotatably disposed between the opening 22a and the winding core 25. The guide shaft 28 extends long sideways and has a rod-shaped configuration. The ink ribbon 23 which has passed through a printing region is guided by the guide shaft 28, introduced into the second core support portion 27 and wound around the winding core 25. Both right end left ends of the guide shaft 28 are respectively snap-engaged with a pair of snap-engagement parts 29 which are formed in the cassette case 22, to be rotatably supported by them.

By rotatably driving the winding core 25, the ink ribbon 23 wound around the supply core 24 is paid off out of the first core support portion 26 through the ribbon supply part 26a. At this time, the ink ribbon 23 is brought into slidably contact with the first wall 26b, and then, travels across the opening 22a. Thereafter, the ink ribbon 23 is guided by the guide shaft 28 in such a way as to be diverted in its traveling direction by about 90° and wound around the winding core 25.

When the ribbon cassette 21 is mounted to a cassette mounting section of the thermal transfer printer, a winding bobbin (not shown) of the thermal transfer printer is engaged with engaging parts 25a which are formed on an inner circumferential surface of the winding core 25. As the winding bobbin is rotated, the winding core 25 is rotated, by which the ink ribbon 23 supplied from the supply core 24 is wound around the first winding core 25.

[Patent Document 1]

Japanese Patent Laid-open Publication No. 2002-144614

[Patent Document 2]

Japanese Patent Laid-open Publication No. 2001-205879

However, in the conventional ribbon cassette 21 constructed as mentioned above, problems are caused in that, since the first wall 26b extends straight and is formed to have the same width, creases may be made in the ink ribbon 32 which travels during printing, or meandering of the ink ribbon 23 may occur.

If creases are made in the ink ribbon 23 during printing, ink contained in a portion of the ink ribbon 23 which is formed with the creases is not properly transferred to a recording paper, which consequently deteriorates the quality of printed images.

Also, in the conventional ribbon cassette 21 as mentioned above, because the guide shaft 28 is snap-engaged with the pair of snap-engagement parts 29, there is a probability that the guide shaft 28 is disengaged from the snap-engagement parts 29 due to a shock when the ribbon cassette 21 is inadvertently dropped to a floor.

In an effort to cope with this problem, if the guide shaft 28 is tightly snap-engaged with the snap-engagement parts 29, smooth rotation of the guide shaft 28 cannot be ensured, and travel of the ink ribbon 23 can be made unstable. Consequently, the ink ribbon 23 is likely to crease or meander.

### SUMMARY OF THE INVENTION

The present invention is made to solve the above problems, and it is an object of the present invention to provide a ribbon cassette which is constructed to prevent an ink ribbon from meandering while the ink ribbon is wound around a winding core from a supply core, thereby performing high quality image printing.

Another object of the present invention is to provide a ribbon cassette which is constructed to prevent a guide shaft supported by a cassette case from being separated from the cassette case even when a shock is applied to the ribbon cassette at the time of the dropping or the like thereof, while ensuring smooth rotation of the guide shaft.

As first means for achieving the above objects, there is provided a ribbon cassette comprising a cassette case having a first core support portion, a second core support portion arranged at a predetermined gap from the first core support portion, and connection members for connecting ends of the first and second core support portions to each other, a supply core rotatably held in the first core support portion, a winding core rotatably held in the second core support portion, and a long ink ribbon whose both ends are wound around the supply core and the winding core, respectively, the ribbon cassette being constructed such that the ink ribbon from the supply core is wound around the winding core after passing through an opening formed between the first core support portion and the second core support portion, in which a ribbon guide part is formed between the ribbon supply part and opening of the cassette case in a manner such that a guide surface of the ribbon guide part which is brought into slidably contact with the ink ribbon constitutes a meandering preventing portion to prevent the ink ribbon from meandering. By the feature having the meandering preventing portion, the ink ribbon is prevented from meandering while traveling across the opening. As a result, creases due to the meandering are not made in the ink ribbon.

As second means for achieving the above objects, a portion of the meandering preventing portion, which is to be brought into slidably contact with a widthwise middle portion of the ink ribbon, is bulged nearer toward the supply core than portions of the meandering preventing portion, which are to be brought into slidably contact with both widthwise ends of the ink ribbon. By this feature having the meandering preventing portion, a tensile force is induced in the ink ribbon to stretch the ink ribbon in a widthwise direction, whereby it is possible to prevent the ink ribbon from creasing or meandering during printing.

As third means for achieving the above objects, the portion of the meandering preventing portion, which is to be brought into slidably contact with the widthwise middle portion of the ink ribbon, is bulged toward the supply core in such a way as to define an arc-shaped contour. By this feature, it is possible to more reliably prevent the ink ribbon from creasing or meandering during printing.

As fourth means for achieving the above objects, the ribbon cassette further comprises a guide shaft having both longitudinal ends which are rotatably fitted into first and second holes formed in the cassette case adjacent to the winding core with respect to the opening, to guide the path of the ink ribbon. By this feature, even when the ribbon cassette is inadvertently dropped to the floor, the guide shaft is prevented from being separated from the cassette case, whereby the guide shaft can reliably guide the ink ribbon.

As fifth means for achieving the above objects, the first hole is formed through a first wall portion which is formed to protrude on the cassette case and has a predetermined thickness; the second hole is formed through a second wall portion formed opposite to the first wall portion so as to face the first hole; and the guide shaft is rotatably supported in the first and second holes by having its one end inserted in one direction through the first hole to project out of the first hole, and having the other end placed on the cassette case adjacent to the second hole and then sled in a direction to be fitted into the second hole. By this feature, the assembling process can be improved when attaching the guide shaft to the cassette case.

As sixth means for achieving the above objects, a guide groove for guiding the other end of the guide shaft into the second hole is formed in the cassette case, adjacent to the second hole, on which the other end of the guide shaft is placed. By this feature, the other end of the guide shaft can be reliably guided to be inserted into the second hole, more effectively, which further improves the assembly process.

As seventh means for achieving the above objects, the cassette case is provided with a first cover for covering an upper portion of the supply core and a second cover for covering an upper portion of the winding core; and a regulating portion, which abuts on one end of the guide shaft fitted into the first hole to regulate the axial movement of the guide shaft, is formed on the second cover. By this feature, it is possible to effectively prevent the guide shaft from being unintentionally separated from the cassette case.

### BRIEF DESCRIPTION OF THE DRAWINGS

FIG. 1 is an exploded perspective view illustrating a ribbon cassette according to the present invention;

FIG. 2 is a plan view explaining an assembling procedure of the ribbon cassette according to the present invention;

FIG. 3 is a plan view explaining the assembling procedure of the ribbon cassette according to the present invention;

FIG. 4 is a plan view explaining the assembling procedure of the ribbon cassette according to the present invention; and

FIG. 5 is a perspective view illustrating a conventional ribbon cassette.

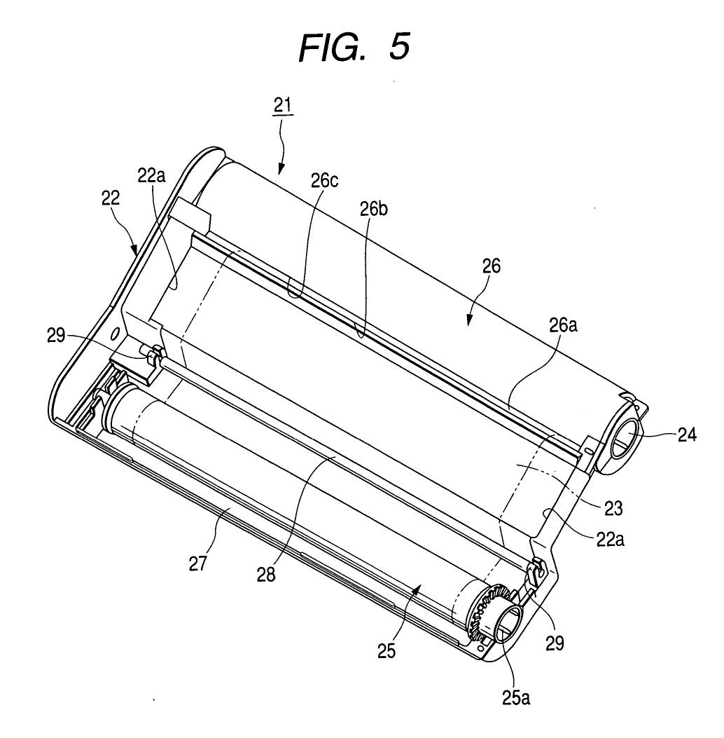

### DESCRIPTION OF THE PREFERRED EMBODIMENT

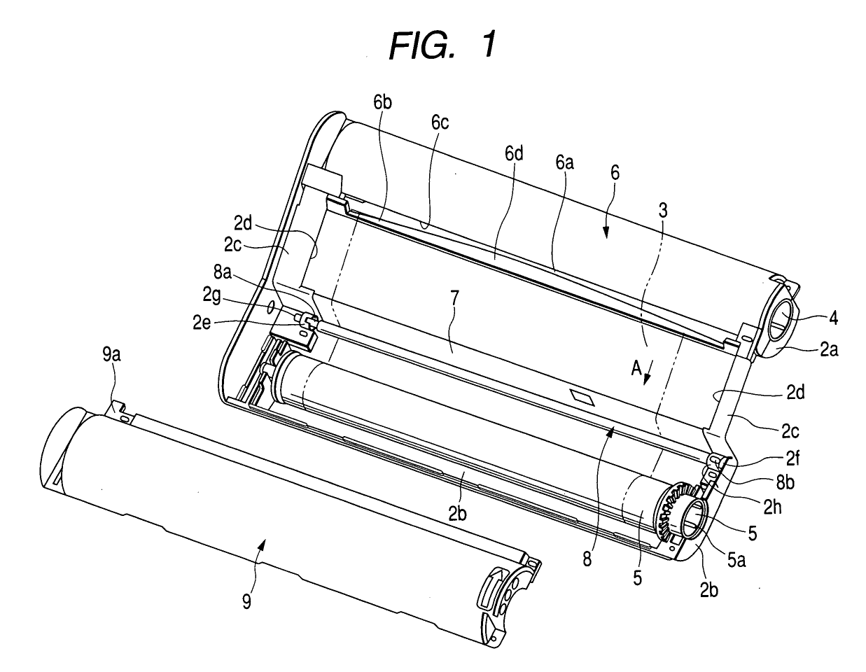

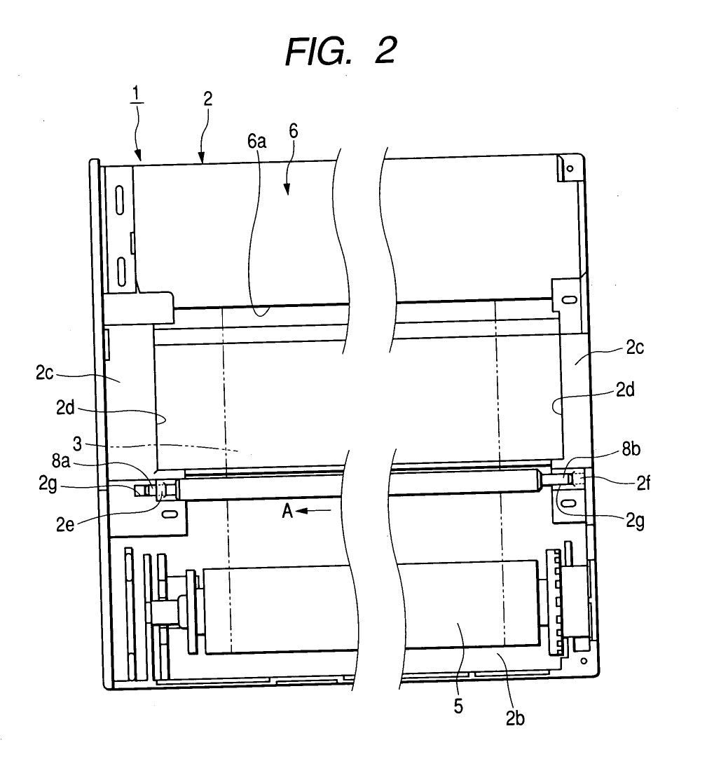

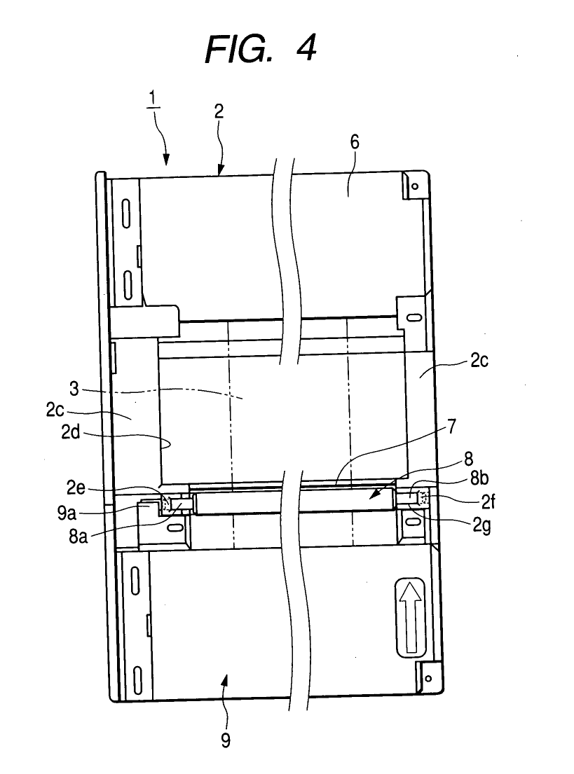

Hereinafter, a ribbon cassette 1 according to an embodiment of the present invention will be described with reference to the drawings. FIG. 1 is an exploded perspective view illustrating the ribbon cassette according to the present invention; and FIGS. 2 to 4 are plan views explaining an assembling procedure of the ribbon cassette according to the present invention.

First, referring to FIG. 1, the ribbon cassette 1 according to the embodiment of the present invention has a cassette case 2 which has a sideways long configuration and is made of a resinous material. A wide ink ribbon 3 as shown by the two-dot chain lines is laid in the cassette case 2. Ink is applied on a face of the ink ribbon 3, and both ends of the ink-ribbon 3 are wound around a supply core 4 and a winding core 5.

The supply core 4 is rotatably supported by a first core support portion 2a which is formed in the cassette case 2. The winding core 5 is rotatably supported by a second core support portion 2b which is formed in the cassette case 2.

Both longitudinal ends of the first and second core support portions 2a and 2b are integrally connected with each other by bar-shaped connection members 2c. An opening 2d is formed between the connection members 2c. A thermal head of a printer (not shown) is located in the opening 2d to press the ink ribbon 3 against a platen roller (not shown) via a recording medium (not shown).

A first cover 6 is placed on the supply core 4, supported by the first core support portion 2a, with the ink ribbon 3 wound around the supply core 4, to protect the ink ribbon 3.

A slit-shaped ribbon supply part 6a is formed between the first cover 6 and the cassette case 2. The ink ribbon 3 wound around the supply core 4 is paid off to the outside through the ribbon supply part 6a. Then, the ink ribbon 3 travels across the opening 2d in the direction ‘A’ indicated by the arrow, and is wound around the winding core 5.

First and second wall surfaces 6b and 6c, which are positioned opposite to each other with a predetermined gap between them, are formed on both sides of the ribbon supply part 6a.

The first wall surface 6b becomes a guide surface capable of guiding the ink ribbon 3 which is supplied from the supply core 4 to travel across the opening 2d and then to be wound around the winding core 5. The guide surface serves as a meandering preventing portion 6d for preventing the ink ribbon 3 from meandering while traveling across the opening 2d.

The meandering preventing portion 6d is formed in such a manner that a portion of the meandering preventing portion 6d which is brought into slidably contact with a widthwise middle portion of the ink ribbon 3 is bulged nearer toward the supply core 4 than portions of the meandering preventing portion 6d which are brought into slidably contact with both widthwise ends of the ink ribbon 3. That is to say, the meandering preventing portion 6d is formed such that the thickness of a widthwise middle portion of the first wall surface 6b is greater than that of both widthwise ends of the first wall surface 6b.

For this reason, a tensile force is induced in the ink ribbon 3 which is paid off while being brought into slidably contact with the first wall surface 6b, to stretch the ink ribbon 3 in a widthwise direction. By the tensile force, since the ink ribbon 3 is prevented from creasing or meandering during printing, it is possible to perform high quality image printing.

A sideways long partition wall 7 is uprightly formed on the side, nearer to an observer in the drawing, to face the first core support portion 2a with respect to the opening 2d. A rod-shaped guide shaft 8 made of metal is rotatably disposed at a corner of the partition wall 7 on the lower side thereof to extend along the partition wall 7.

A left end 8a of the guide shaft 8 is rotatably fitted into a first hole (not shown) formed in a first wall portion 2e which is formed on the cassette case 2.

A right end 8b of the guide shaft 8 is rotatably fitted into a second hole (not shown) formed in a second wall portion 2f which is formed on the cassette case 2.

In other words, both longitudinal ends of the guide shaft 8 are rotatably supported in the first and second holes of the first and second wall portions 2e and 2f, respectively, which are formed on the cassette case 2.

Guide grooves 2g and 2h are formed in the cassette case 2 adjacent to the first and second wall portions 2e and 2f to guide the left and right ends 8a and 8b of the guide shaft 8 into the first and second holes of the first and second wall portions 2e and 2f, respectively.

Here, only the guide groove 2h of the guide grooves 2g and 2h is formed adjacent to the second wall portion 2f only. Namely, it is sufficient that the guide groove 2h is formed in the cassette case 2 at least adjacent to the second hole formed in the second wall portion 2f to guide the right end 8b of the guide shaft 8 into the second hole.

A second cover 9 is detachably placed on the winding core 5 which is rotatably supported by the second core support portion 2b, to cover the winding core 5.

A regulating portion 9a is formed to protrude on the second cover 9. The regulating portion 9a abuts on the left end 8a of the guide shaft 8, which is fitted into the first hole of the first wall portion 2e. Thereby, the regulating portion 9a functions to regulate the axial movement of the guide shaft 8.

The second cover 9 is placed on the winding core 5 which is placed on the second core support portion 2b, whereby the winding core 5 is rotatably received in and supported by the second core support portion 2b.

In order to assemble the ribbon cassette 1 constructed as mentioned above, first, the supply core 4 and winding core 5, around which both ends of the ink ribbon 3 are respectively wound, are prepared.

The supply core 4 is then placed in the first core support portion 2a of the cassette case 2, and the winding core 5 is placed in the second core support portion 2b of the cassette case 2.

Thereafter, the first cover 6 is mounted to the cassette case 2 to cover the supply core 4 from above. Next, the guide shaft 8 is located on the ink ribbon 3 between the partition wall 7 and the winding core 5. In this state, the guide shaft 8 is pressed downward along the partition wall 7 while being kept horizontal. Thereupon, a portion of the ink ribbon 3 which is pressed by the guide shaft 8 is lowered along the partition wall 7, as a result of which the ink ribbon 3 is diverted in its traveling direction by about 90° when viewed from a side, to define a crank-shaped outline.

The left end 8a of the guide shaft 8 which is lowered along the partition wall 7 is positioned in the guide groove 2g adjacent to the first wall portion 2e. Next, by sliding the guide shaft 8 in a leftward direction as shown by the arrow ‘A’ in FIG. 2, the left-end 8a of the guide shaft 8 is fitted into the first hole to project leftward beyond the first wall portion 2e.

At this time, the right end 8b of the guide shaft 8 is positioned in the guide groove 2h adjacent to the second wall portion 2f.

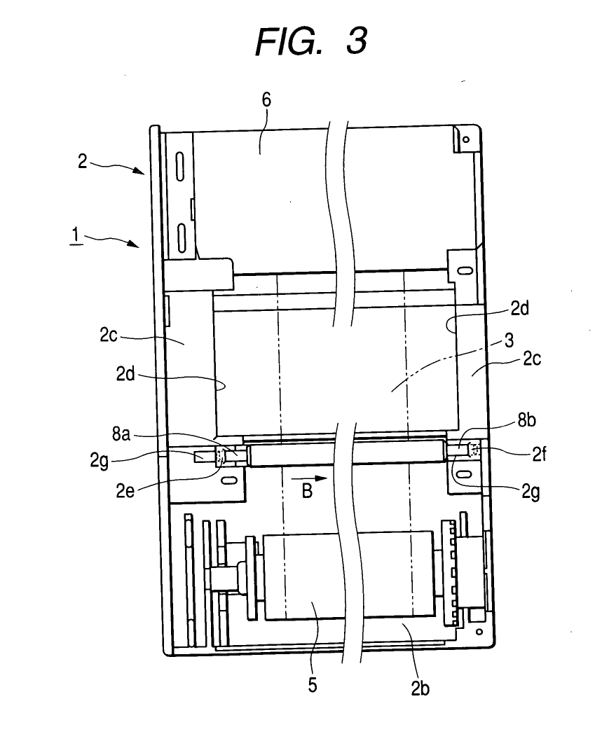

Next, by sliding the guide shaft 8 in a rightward direction as shown by the arrow ‘B’ in FIG. 3, the right end 8b is guided into the guide groove 2h and fitted into the second hole of the second wall portion 2f. And, the left end 8a of the guide shaft 8 which is fitted into the first hole becomes flush with an outer surface of the first wall portion 2e. At this time, both ends of the guide shaft 8 are rotatably supported in the first and second holes (not shown) formed in the first and second wall portions 2e and 2f, respectively.

Then, by mounting the second cover 9 to the cassette case 2 from above the winding core 5 received in the second core support portion 2b to cover the winding core 5, the regulating portion 9a of the second cover 9 abuts on the left end 8a of the guide shaft 8. Thereby, the axial movement of the guide shaft 8 is regulated, and the guide shaft 8 is prevented from being unintentionally separated from the cassette case 2.

In the ribbon cassette 1 according to the present invention, even when the ribbon cassette 1 is inadvertently dropped to the floor such as when attaching or detaching the ribbon cassette 1 to or from a printer, both ends of the guide shaft 8 are prevented from being removed from the first and second holes of the first and second wall portions 2e and 2f.

When the ribbon cassette 1 of the present invention as assembled in this way is mounted to a cassette loading section of a thermal transfer printer (not shown), engaging parts 5a which are formed on an inner circumferential surface of the winding core 5 are engaged with a winding bobbin of the thermal transfer printer. As the winding bobbin is rotated, the winding core 5 is simultaneously rotated, by which the ink ribbon 3 having conducted a printing task is wound around the winding core 5.

Thereafter, a recording paper (not shown) is fed between the platen roller (not shown) of the thermal transfer printer and the ink ribbon 3, and a thermal head (not shown) which is composed of a line head facing the opening 2d is moved downward to press the ink ribbon 3 and the platen roller against the recording paper.

Then, a plurality of heat generating elements of the thermal head are selectively heated on the basis of printing information, and paper feeding rollers (not shown) are driven to feed the recording paper.

Next, ink contained in the ink ribbon 3 which is brought into close contact with a recording paper is thermally transferred to the recording paper to print desired image on the recording paper.

The ink ribbon 3 after the printing task is peeled off from the recording paper by the rotation of the winding core 5, to be wound around the winding core 5.

During the printing, the ink ribbon 3 is paid off through the ribbon supply part 6a and drawn out to the opening 2d while being brought into slidably contact with the first wall surface 6b which is formed with the meandering preventing portion 6d. At this time having the tensile force applied to the ink ribbon 3 in the ink ribbon-winding direction ‘A’ and the tensile force applied to the ink ribbon 3 to stretch the ink ribbon 3 in the widthwise direction, it is possible to tightly supply the ink ribbon 3 through the thermal head.

Thus, the ink ribbon 3 can be pressed against the recording paper while being prevented from creasing or meandering, whereby it is possible to perform high quality image printing on a recording paper.

While it has been described in the above embodiment that, in order to create the meandering preventing portion, the widthwise middle portion of the first wall surface 6b is bulged upstream when viewed in the ink ribbon-winding direction ‘A’ and thereby defines an arc-shaped contour, it can be contemplated that, in order to create the meandering preventing portion, the middle portion of the meandering preventing portion bulged toward the upstream of the first wall surface 5b is formed straight and ridge lines that connect the straight middle portion with the both ends are formed to have a trapezoidal sectional shape (not shown).

Also, while it has been described in the above embodiment that in order to create the meandering preventing portion, the widthwise middle portion of the first wall surface 6b which is to be brought into slidably contact with the widthwise middle portion of the ink ribbon 3 is bulged upstream when viewed in the ink ribbon-winding direction ‘A’, it can be contemplated that the widthwise middle portion of the first wall surface 6b is formed to simply project toward the supply core 4 by a predetermined thickness.

1. A ribbon cassette comprising:
a cassette case having a first core support portion, a second core support portion arranged at a predetermined gap from the first core support portion, and connection members for connecting ends of the first and second core support portions to each other,
a supply core rotatably held in the first core support portion,
a winding core rotatably held in the second core support portion, and
a long ink ribbon whose both ends are wound around the supply core and the winding core, respectively,
the ribbon cassette being constructed such that the ink ribbon wound around the supply core is drawn out from a ribbon supply part and is wound around the winding core after passing through an opening formed between the first core support portion and the second core support portion,
wherein a ribbon guide part is formed between the ribbon supply part and opening of the cassette case such that a guide surface of the ribbon guide part which is brought into slidable contact with the ink ribbon constitutes a meandering preventing portion to prevent the ink ribbon from meandering.

2. The ribbon cassette according to claim 1, wherein a portion of the meandering preventing portion, which is to be brought into slidable contact with a widthwise middle portion of the ink ribbon, is bulged nearer toward the supply core than portions of the meandering preventing portion, which are to be brought into slidable contact with both widthwise ends of the ink ribbon.

3. The ribbon cassette according to claim 2, wherein the portion of the meandering preventing portion, which is to be brought into slidable contact with the widthwise middle portion of the ink ribbon, is bulged toward the supply core in such a way as to define an arc-shaped contour.

4. The ribbon cassette according to claim 2, further comprising:
a guide shaft having both longitudinal ends which are rotatably fitted into first and second holes formed in the cassette case adjacent to the winding core with respect to the opening, to guide a path of the ink ribbon.

5. The ribbon cassette according to claim 4, wherein the first hole is formed through a first wall portion which is formed to protrude on the cassette case and has a predetermined thickness; the second hole is formed through a second wall portion formed opposite to the first wall portion so as to face the first hole; and the guide shaft is rotatably supported in the first and second holes by having one end inserted in one direction through the first hole to project out of the first hole, and having an other end placed on the cassette case adjacent to the second hole and then slid in a direction to be fitted into the second hole.

6. The ribbon cassette according to claim 5, wherein a guide groove for guiding the other end of the guide shaft into the second hole is formed in the cassette case, adjacent to the second hole, on which the other end of the guide shaft is placed.

7. The ribbon cassette according to claim 6, wherein the cassette case is provided with a first cover for covering an upper portion of the supply core and a second cover for covering an upper portion of the winding core; and a regulating portion, which abuts on the one end of the guide shaft fitted into the first hole to regulate the axial movement of the guide shaft, is formed on the second cover.
